(19) United States
(12) Patent Application Publication
(10) Pub. No.: US 2026/0101296 A1
(43) Pub. Date: Apr. 9, 2026

(54) SYSTEMS AND METHODS FOR OBTAINING A TIMING USING A NETWORK TIME PROTOCOL AND A SYSTEM FRAME NUMBER

(71) Applicant: Verizon Patent and Licensing Inc., Basking Ridge, NJ (US)

(72) Inventor: Weimin LIU, Chatham, NJ (US)

(73) Assignee: Verizon Patent and Licensing Inc., Basking Ridge, NJ (US)

(21) Appl. No.: 18/905,989

(22) Filed: Oct. 3, 2024

(51) Int. Cl. H04W 56/00

(52) U.S. Cl. CPC H04W 56/0015; H04W 56/0045

(57) ABSTRACT

In some implementations, a device may receive a synchronization signal. The device may synchronize with a wireless communication network based on the synchronization signal, wherein the device is associated with a radio frame based on the synchronization signal, and the radio frame is associated with a system frame number (SFN). The device may receive a time reference associated with a network time protocol (NTP). The device may obtain a timing based on the SFN and the NTP.

### BACKGROUND

Wireless communication systems are widely deployed to provide various telecommunication services such as telephony, video, data, messaging, and broadcasts. A wireless network may include one or more network nodes that support communication for wireless communication devices, such as a user equipment (UE).

### BRIEF DESCRIPTION OF THE DRAWINGS

FIG. 1 is a diagram of an example associated with obtaining a time reference using a network time protocol (NTP).

FIG. 2 is a diagram of an example associated with obtaining a timing using an NTP and a system frame number (SFN).

FIG. 3 is a diagram of an example associated with obtaining a timing using an NTP and an SFN.

FIG. 4 is a diagram of an example environment in which systems and/or methods described herein may be implemented.

FIG. 5 is a diagram of example components of one or more devices of FIG. 4.

FIG. 6 is a flowchart of an example process associated with obtaining a timing using an NTP and an SFN.

### DETAILED DESCRIPTION OF EXAMPLE EMBODIMENTS

The following detailed description of example implementations refers to the accompanying drawings. The same reference numbers in different drawings may identify the same or similar elements.

Coordinated Universal Time (UTC) is a primary time standard globally used to regulate clocks and time. UTC establishes a reference for a current time and forms a basis for time zones. UTC is based on International Atomic Time (TAI), which is a weighted average of hundreds of atomic clocks worldwide. UTC time starts from midnight Jan. 1, 1970. A difference between UTC and TAI is a number of leap seconds since 1972 (28 leap seconds as of 2020). A global positioning system (GPS) time, which is maintained by the United States Naval Observatory (USNO), is based on the TAI. GPS time zero is 00:00:19 TAI Jan. 6, 1980 (TAI is always ahead of GPS time by 19 seconds).

Legal sources of time standard in the United States include the National Institute of Standards and Technology (NIST) and the USNO, where the NIST is for electrical power and final sectors, and the USNO is for defense and GPS. The NIST and the USNO are both parts of a UTC ensemble, namely UTC (NIST) and UTC (USNO).

Different time services in various industries (different use cases) may be associated with different synchronization requirements or accuracy requirements. Such industries may include smart grids, banking and points-of-sale (POS), media production, sensors and testing, health, and/or consumer. Synchro-phasors (smart grid), a network clock as a grandmaster on site (smart grid), and/or audio/video production (media production) may be associated with a synchronization requirement of less than 1 microsecond (μs). A power protection system (smart grid), high-frequency trading (banking and POS), live audio streaming (media production), mobile network service level agreement (SLA) testing (sensors and testing), robotic aided surgery (health), extended reality (XR) (consumer), virtual reality (VR) (consumer), and/or the metaverse (consumer) may be associated with a synchronization requirement of less than 100 μs. A supervisory control and data acquisition system (smart grid), event reporting and disturbance (smart grid), non-high-frequency trading (banking and POS), and/or ultra-realistic interactive sport (consumer) may be associated with a synchronization requirement of less than 1 millisecond (ms). A control room (smart grid), real-time payments (banking and POS), human trading (banking and POS), mobility event testing (sensors and testing), tele-operated field robots (consumer), and/or clocks/watches (consumer) may be associated with a synchronization requirement of less than 100 ms.

NTP is an application-layer protocol over internet protocol (IP) networks. NTP has been used for decades for obtaining a time reference by computers and other devices that have a connection to the Internet. NTP is widely used for synchronizing computers and Internet of Things (IoT) devices, such as clocks, security cameras, etc. An accuracy of time obtained via NTP may be accurate to tens of milliseconds, relative to UTC, due to uncertainty in NTP itself and due to latency jitters and/or asymmetry in the Internet connection to an NTP server. NTP may be used by computers to set their own operating system clocks.

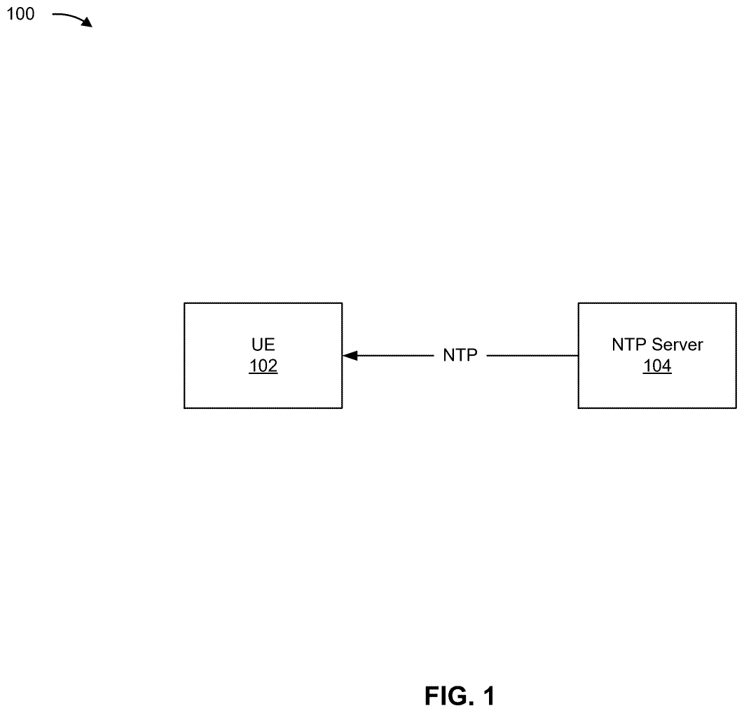

FIG. 1 is a diagram of an example 100 associated with obtaining a time reference using an NTP. The example 100 includes a UE 102 and an NTP server 104.

As shown in FIG. 1, the UE 102 may receive a time reference from an NTP server 104 over the Internet. For example, the UE 102 may be a camera, a computer, or any other type of suitable electronic device. Due to uncertainty in the NTP itself and due to latency jitters and/or asymmetry in the Internet connection to the NTP server 104, the time reference obtained using the NTP may be associated with an inaccuracy on the order of tens of milliseconds in relation to UTC.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

A radio interface of a cellular network, such as a Fourth Generation (4G) network or a Fifth Generation (5G) time division duplexing (TDD) network, may run on a relatively precise timing (e.g., about 100 ns to 10 μs depended on supported features). The cellular network may run on repeated radio frames that are 10 ms long. Each radio frame may be designated a 10-bit cyclic counter, referred to as a system frame number (SFN), which may range from 0 to 1023. The SFN may be incremented every 10 ms and repeated every 10.24 seconds. A network node in the cellular network may broadcast cellular signals, which may be decoded by a user equipment (UE) for synchronization before the UE attempts to attach to the cellular network. The cellular signals may include a primary synchronization signal (PSS), a secondary synchronization signal (SSS), and/or a physical broadcast channel (PBCH) signal. In a 4G cellular network, especially for frequency division duplexing (FDD) bands, the SFN is not required to start from a certain origin. In a 5G TDD cellular network, such as a 5G non-isolated TDD network, SFN=0 starts on Jan. 6, 1980, at 00:00:19 TAI, which is the same as GPS time. The SFN is determined by GPS time using SFN=(GPS time×100) mod 1024, which repeats every 10.24 seconds.

In a cell search procedure, an SFN acquisition by the UE may occur. Before the UE is attached to the cellular network (e.g., the 5G TDD network), the UE may need to acquire relative time and frequency synchronization with a cell. The UE may listen for and decode the PBCH signal. The SFN may be partially encoded in a master information block (MIB) inside the PBCH signal and partially encoded in a channel code of the PBCH signal. When the UE is successfully synchronized with the cell, the UE acquires information on the continually-changing SFNs and is synchronized with radio frames corresponding to the SFNs. During the cell search procedure, the UE does not need to be provisioned to the cellular network.

Due to an SFN origin requirement for the 5G TDD network, the UE may derive GPS time or UTC time from the SFN, but an ambiguity may exist in multiples of 10.24 seconds. For example, the UE may be unable to determine a number of SFN cycles that have elapsed since Jan. 6, 1980 at 00:00:19 TAI. A usage of the SFN may achieve a timing accuracy of a few microseconds due to a propagation delay from a cell tower to the UE, but the SFN may be associated with an ambiguity of multiples of 10.24 seconds. The UE may be synchronized to an exact SFN number, but the UE is not aware of how many SFN cycles have occurred since Jan. 6, 1980 at 00:00:19 TAI. The SFN may be more accurate, compared to the NTP, but may be associated with ambiguity.

A time reference obtained using the NTP may achieve a timing accuracy in the tens of milliseconds due to uncertainty in the NTP and due to latency jitters and asymmetry in an Internet connection to an NTP server. An inaccuracy of time obtained from the NTP server over the Internet may be in the tens of milliseconds. The NTP may be less accurate, compared to the SFN, but may not be associated with any ambiguity. Such a timing accuracy may be unsuitable for certain use cases, such as robot-aided surgery, high-frequency trading, live audio streaming, XR, and others. As a result, the time reference obtained using the NTP may not be useable for such use cases.

In some implementations, a timing accuracy based on the SFN and the NTP may be obtained. The SFN may be combined with the NTP to achieve the time accuracy on the order of a few microseconds. An ambiguity associated with the SFN may be resolved using the NTP. In other words, the time reference obtained using the NTP may be updated using the SFN, thereby achieving the timing accuracy based on the SFN and the NTP.

In some implementations, the NTP may be combined with the SFN to achieve a timing accuracy (or synchronization accuracy) on the order of a few microseconds. Combining the NTP and the SFN may produce an accurate and unambiguous time reference. Such a timing accuracy may be achieved on any UE that has access to the Internet and a radio receiver (e.g., a 5G radio receiver). A subscriber identification module (SIM) card may not be required. The timing accuracy obtained from the NTP may be improved by leveraging the presence of cellular signals (e.g., 5G cellular signals). By leveraging the cellular signals, the UE does not need to be provisioned for a cellular network, as the UE simply needs to utilize detectable cellular signals from any public cellular network. A resulting timing accuracy may be improved to be within several microseconds, which is an improvement of three or four orders of magnitude, as compared to when the NTP alone is utilized. The resulting timing accuracy may not require provisioning and may utilize detectable cellular signals from any public cellular network. The resulting timing accuracy may allow various use cases to become available, where the various use cases may involve applications in industry, finance, entertainment, medicine, and other fields.

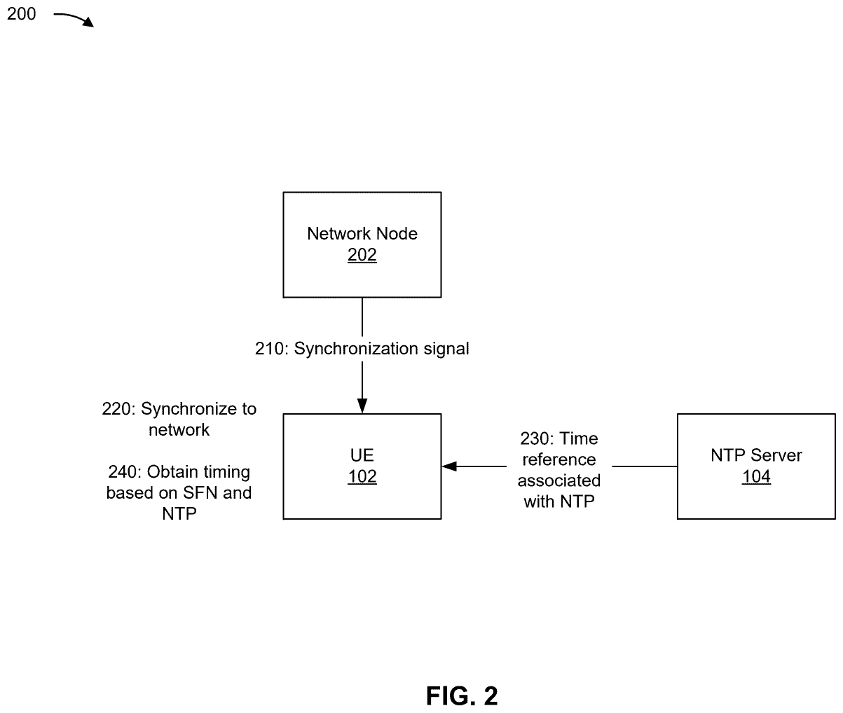

FIG. 2 is a diagram of an example 200 associated with obtaining a timing using an NTP and an SFN. The example 200 includes a UE 102, an NTP server 104, and a network node 202 (e.g., a 5G cell). The network node 202 may be associated with a time source that is traceable to UTC. The network node 202 may be included in a wireless communication network.

As shown by reference number 210, the UE 102 may receive, from the network node 202, a synchronization signal. The synchronization signal may be a broadcast signal. The synchronization signal may be a PSS, an SSS, and/or a PBCH signal. The UE 102 may receive the synchronization signal during a cell search procedure. The UE 102 may or may not be provisioned to receive the synchronization signal from the network node 202. The network node 202 may be associated with a public network or a non-public network.

As shown by reference number 220, the UE 102 may synchronize with the network node 202 based on the synchronization signal. The UE 102 may be associated with a radio frame based on the synchronization signal. The radio frame may be associated with an SFN. During a synchronization, the UE 102 may be locked on a radio frame boundary associated with the radio frame. The radio frame may be associated with a duration of 10 ms. The SFN may range from 0 to 1023. The SFN may be incremented every 10 ms and repeated every 10.24 seconds.

As shown by reference number 230, the UE 102 may receive, from the NTP server 104, a time reference associated with an NTP. A timing accuracy associated with the time reference may be in the tens of milliseconds, relative to a UTC. The UE 102 may receive the time reference associated with the NTP from the NTP server 104 over the Internet. The NTP is an application-layer protocol over IP networks.

As shown by reference number 240, the UE 102 may obtain a timing based on the SFN and the NTP. The UE 102 may combine the SFN with the NTP to achieve a time accuracy on the order of a few microseconds. The UE 102 may resolve an ambiguity associated with the SFN using the NTP. In other words, the time reference associated with the NTP may be updated using the SFN, thereby achieving the timing accuracy based on the SFN and the NTP. The timing accuracy may be an improved timing accuracy as compared to when a timing is obtained using only the SFN or only the NTP.

In some implementations, the SFN may be set according to a GPS time. The GPS time may be based on the time reference associated with the NTP. The GPS time may be estimated based on the SFN and an unknown positive integer representing an ambiguity in a number of SFN cycles that have elapsed since a GPS time zero. Alternatively, the SFN may be set according to a global navigation satellite system (GNSS) time. The UE 102 may determine an estimated GPS time at an SFN boundary from the SFN in accordance with the SFN and the unknown positive integer representing the ambiguity in the number of SFN cycles that have elapsed since the GPS time zero. The UE 102 may calculate the unknown positive integer representing the ambiguity, for a current SFN cycle, based on an estimated GPS time at an SFN=0 boundary from the NTP. The UE 102 may calculate a time difference between the estimated GPS time at the SFN boundary from the SFN and the estimated GPS time at the SFN=0 boundary from the NTP, where the time difference may be associated with the timing based on the SFN and the NTP. The UE 102 may update a system time based on the time difference, where a synchronization of the UE 102 with the wireless communication network may be based on the time difference. The UE 102 may provide the time difference to an application running on the UE 102.

In some implementations, the UE 102 may obtain the time reference from the NTP server 104 over the Internet and achieve synchronization with the network node 202. When the UE 102 is synchronized with the network node 202 (e.g., a 5G cell tower), the UE 102 may be locked on the radio frame boundary (10 ms each) with microsecond accuracy. The UE 102 may be locked on the radio frame boundary based on the synchronization signal, where each radio frame may be associated with the SFN. The microsecond accuracy (or inaccuracy) may be a result of the network node 202 itself having some time tolerance (e.g., less than 1.5 μs), a propagation delay from the network node 202 to the UE 102 (approximately 1 μs for every 300 ms), and/or any processing delay uncalibrated in a receiver of the UE 102.

In some implementations, after obtaining the time reference from the NTP server 104, the UE 102 may use the obtained time reference to resolve the ambiguity in the SFN. The time reference received via the NTP server may be associated with UTC, and the UE 102 may calculate the GPS time (GPST) from the UTC with a known offset. For example, in Year 2024, an offset from UTC to GPS time is approximately 18 seconds. In other words, the UE 102 may calculate the GPS time based on the time reference associated with NTP.

In some implementations, at a radio frame boundary of a 10 ms radio frame, the UE 102 may determine an SFN corresponding to that radio frame boundary. The UE 102 may determine the corresponding SFN from the GPS time, in accordance with:

$$SFN = ( GPST * 100 ) mod ( 1024 ) ,$$

where GPST is the GPS time (in seconds), and mod( ) is the modulo function. The SFN may range from 0 to 1023. The UE 102 may identify SFN+M*1024=GPST*100, where M is an unknown positive integer representing an ambiguity in a number of SFN cycles that has elapsed since a GPS time zero (1980-01-06T00:00:19 TAI). The UE 102 may derive:

$$GPST = ( SFN + M * 1024 ) / 100 = ( SFN / 100 ) + ( M * 10.24 ) .$$

In some implementations, the UE 102 may determine an estimated GPS time [symbol] at the radio frame boundary from a decoded SFN ( [symbol] ) in accordance with:

$$= * 10 ms + M * 10.24 s ,$$

where M increments by 1 every 10.24 seconds in real time.

In some implementations, when the estimated GPS time at an SFN=0 boundary from the NTP is [symbol] in seconds, the UE 102 may calculate the ambiguity M for a current SFN cycle in accordance with:

$$= round ( / 10.24 s ) ,$$

where round( ) is a rounding function.

In some implementations, since an expected time accuracy from NTP is in tens of milliseconds, much shorter than an SFN cycle of 10.24 seconds (10,240 ms), a chance that an error occurs, e.g., [symbol] ≠M, is relatively low. In some cases, [symbol] may be filtered using a majority vote algorithm or other traditional techniques. In some implementations, the estimated GPS time [symbol] at the radio frame SFN=0 boundary from the SFN may then be compared with [symbol] , and the time difference may be used to update a UE system time or provide a more accurate time reference for other applications running on the UE 102.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

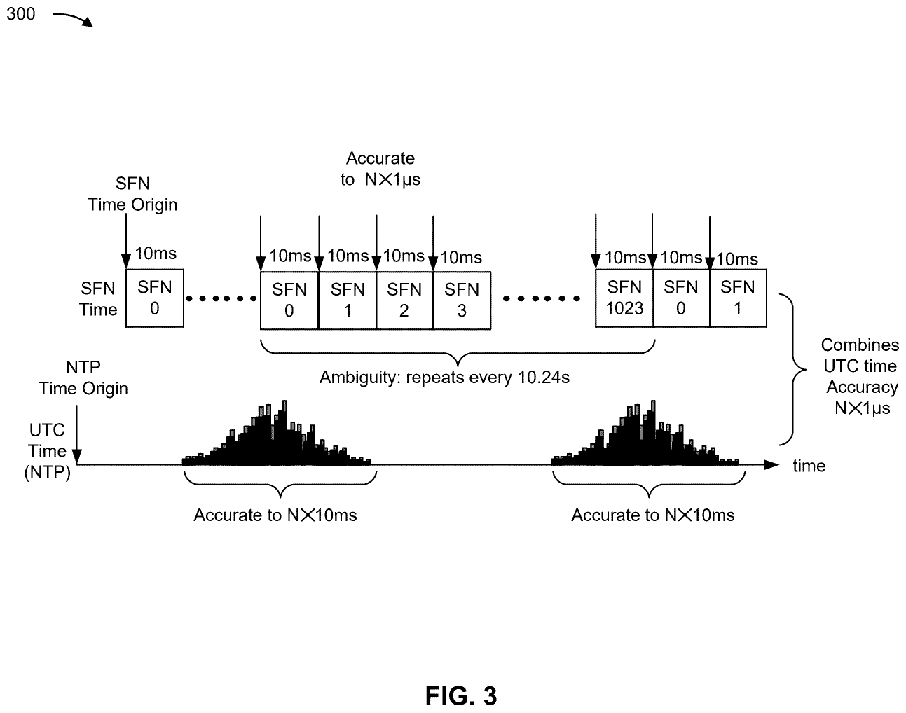

FIG. 3 is a diagram of an example 300 associated with obtaining a timing using an NTP and an SFN.

As shown in FIG. 3, an SFN time origin may be associated with SFN. An SFN may range from 0 to 1023. An SFN may be associated with a 10 ms radio frame. At a start of each radio frame, the SFN may be incremented. Since the SFN ranges from 0 to 1023 and each radio frame is 10 ms long, an SFN may repeat every 10.24 seconds. An NTP time origin may be associated with NTP (UTC time). NTP time has no ambiguity but is relatively inaccurate (e.g., inaccuracy on the order of tens of milliseconds). SFN time is relatively accurate but has ambiguity by itself. By combining NTP time and SFN time, an improved time accuracy may be achieved.

As indicated above, FIG. 3 is provided as an example. Other examples may differ from what is described with regard to FIG. 3.

In some implementations, a precision time protocol (PTP) is a time protocol that has an accuracy in microseconds or even nanoseconds over calibrated fiber, but PTP may require a wired connection, hardware/firmware support in a UE's Ethernet port, and a complicated infrastructure of PTP-capable routers and servers. In some implementations, a UE may use navigation satellites (e.g., GPS) for time reference, which may have an accuracy in nanoseconds. However, the navigation satellites may require a view of the sky, or antenna wiring, and may have a security concern due to vulnerability to radio jamming and spoofing. In some implementations, as part of an NIST radio broadcast, time and frequency shortwave broadcast radio stations operated by NIST may transmit at 2.5 megahertz (MHz), 5 MHz, 10 MHz, 15 MHz, and 20 MHz. Due to propagation delay, a received time accuracy may be less than 10 ms.

In some implementations, a 4G system information block 16 (SIB16) may be part of system information which, when provided by a 4G cellular network, may carry a UTC time reference for UEs. The 4G SIB16 may be carried on a downlink shared channel (DL-SCH) at a medium access control (MAC) layer and a physical downlink shared channel (PDSCH) at a physical layer. Generally only SIBI to SIB12 is broadcast, so the 4G SIB16 may not necessarily be received by UEs. 4G cellular networks may not necessarily support the 4G SIB16, and the UE would need to be provisioned for a specific mobile network to receive the 4G SIB16. In this case, the 4G SIB16 is not associated with a detectable cellular signal from a public cellular network. With the 4G SIB16, an achievable time accuracy may be presumed to be approximately 1 μs, but in practice the achievable time accuracy is likely less accurate due to the lack of an SFN synchronization requirement in a 4G FDD network.

In some implementations, a 5G system information block 9 (SIB9) may be part of system information, which when provided by a 5G cellular network, may carry a UTC time reference for UEs. The 5G SIB9 may be carried on a DL-SCH at a MAC layer and a PDSCH at a physical layer, which may require the UE to be provisioned for a specific mobile network in order to receive the SIB9. In this case, the 5G SIB9 is not associated with a detectable cellular signal from a public cellular network. With the 5G SIB9, an achievable time accuracy may be approximately less than 1 μs.

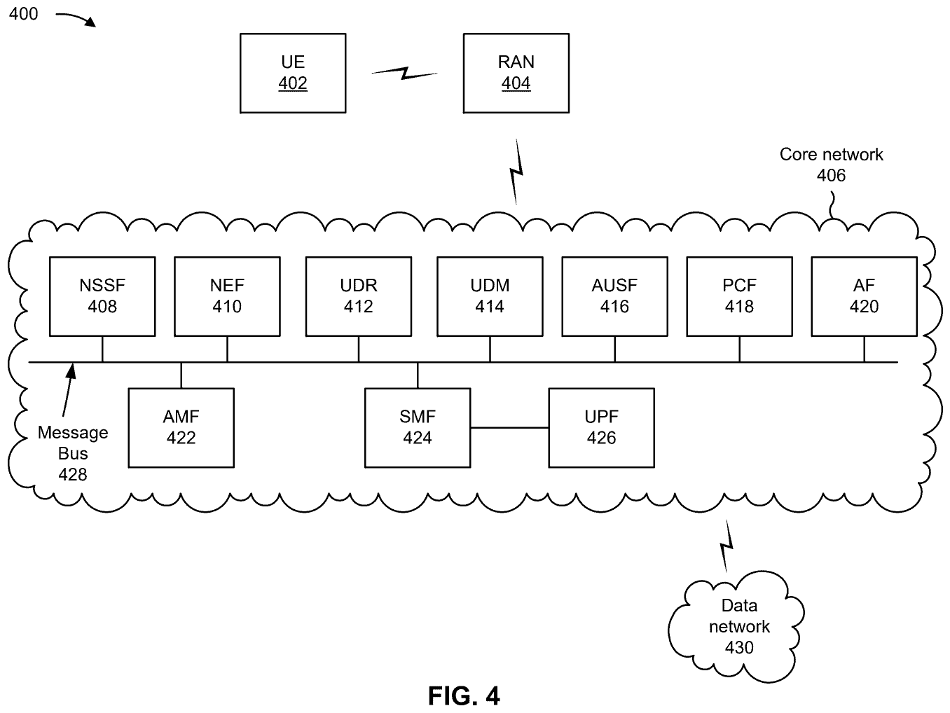

FIG. 4 is a diagram of an example environment 400 in which systems and/or methods described herein may be implemented. As shown in FIG. 4, example environment 400 may include a UE 402, a radio access network (RAN) 404, a core network 406, and a data network 430. Devices and/or networks of example environment 400 may interconnect via wired connections, wireless connections, or a combination of wired and wireless connections.

The UE 402 may include one or more devices capable of receiving, generating, storing, processing, and/or providing information, such as information described herein. For example, the UE 402 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 404 may support, for example, a cellular radio access technology (RAT). The RAN 404 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 402. A base station may be a disaggregated base station. The disaggregated base station may be configured to utilize a protocol stack that is physically or logically distributed among two or more nodes, which may include a radio unit (RU), a distributed unit (DU), and a centralized unit (CU). The RAN 404 may transfer traffic between the UE 402 (e.g., using a cellular RAT), one or more base stations (e.g., using a wireless interface or a backhaul interface, such as a wired backhaul interface), and/or the core network 406. The RAN 404 may provide one or more cells that cover geographic areas.

In some implementations, the RAN 404 may perform scheduling and/or resource management for the UE 402 covered by the RAN 404 (e.g., the UE 402 covered by a cell provided by the RAN 404). In some implementations, the RAN 404 may be controlled or coordinated by a network controller, which may perform load balancing, network-level configuration, and/or other operations. The network controller may communicate with the RAN 404 via a wireless or wireline backhaul. In some implementations, the RAN 404 may include a network controller, a self-organizing network (SON) module or component, or a similar module or component. In other words, the RAN 404 may perform network control, scheduling, and/or network management functions (e.g., for uplink, downlink, and/or sidelink communications of the UE 402 covered by the RAN 404).

In some implementations, the core network 406 may include an example functional architecture in which systems and/or methods described herein may be implemented. For example, the core network 406 may include an example architecture of a 5G next generation (NG) core network included in a 5G wireless telecommunications system. While the example architecture of the core network 406 shown in FIG. 4 may be an example of a service-based architecture, in some implementations, the core network 406 may be implemented as a reference-point architecture and/or a 4G core network, among other examples.

As shown in FIG. 4, the core network 406 may include a number of functional elements. The functional elements may include, for example, a network slice selection function (NSSF) 408, a network exposure function (NEF) 410, a unified data repository (UDR) 412, a unified data management (UDM) 414, an authentication server function (AUSF) 416, a policy charging function (PCF) 418, an application function (AF) 420, an access and mobility management function (AMF) 422, a session management function (SMF) 424, and/or a user plane function (UPF) 426. These functional elements may be communicatively connected via a message bus 428. Each of the functional elements shown in FIG. 4 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 408 may include one or more devices that select network slice instances for the UE 402. The NSSF 408 may allow an operator to deploy multiple substantially independent end-to-end networks potentially with the same infrastructure. In some implementations, each slice may be customized for different services. The NEF 410 may include one or more devices that support exposure of capabilities and/or events in the wireless telecommunications system to help other entities in the wireless telecommunications system discover network services.

The UDR 412 may include one or more devices that provide a converged repository, which may be used by network functions to store data. For example, a converged repository of subscriber information may be used to service a number of network functions. The UDM 414 may include one or more devices to store user data and profiles in the wireless telecommunications system. The UDM 414 may generate authentication vectors, perform user identification handling, perform subscription management, and perform other various functions. The AUSF 416 may include one or more devices that act as an authentication server and support the process of authenticating the UE 402 in the wireless telecommunications system.

The PCF 418 may include one or more devices that provide a policy framework that incorporates network slicing, roaming, packet processing, and/or mobility management, among other examples. The AF 420 may include one or more devices that support application influence on traffic routing, access to the NEF 410, and/or policy control, among other examples. The AMF 422 may include one or more devices that act as a termination point for non-access stratum (NAS) signaling and/or mobility management, among other examples. The SMF 424 may include one or more devices that support the establishment, modification, and release of communication sessions in the wireless telecommunications system. For example, the SMF 424 may configure traffic steering policies at the UPF 426 and/or may enforce UE IP address allocation and policies, among other examples. The UPF 426 may include one or more devices that serve as an anchor point for intra-RAT and/or inter-RAT mobility. The UPF 426 may apply rules to packets, such as rules pertaining to packet routing, traffic reporting, and/or handling user plane QoS, among other examples.

The message bus 428 may represent a communication structure for communication among the functional elements. In other words, the message bus 428 may permit communication between two or more functional elements.

The data network 430 may include one or more wired and/or wireless data networks. For example, the data network 430 may include a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of example environment 400 may perform one or more functions described as being performed by another set of devices of example environment 400.

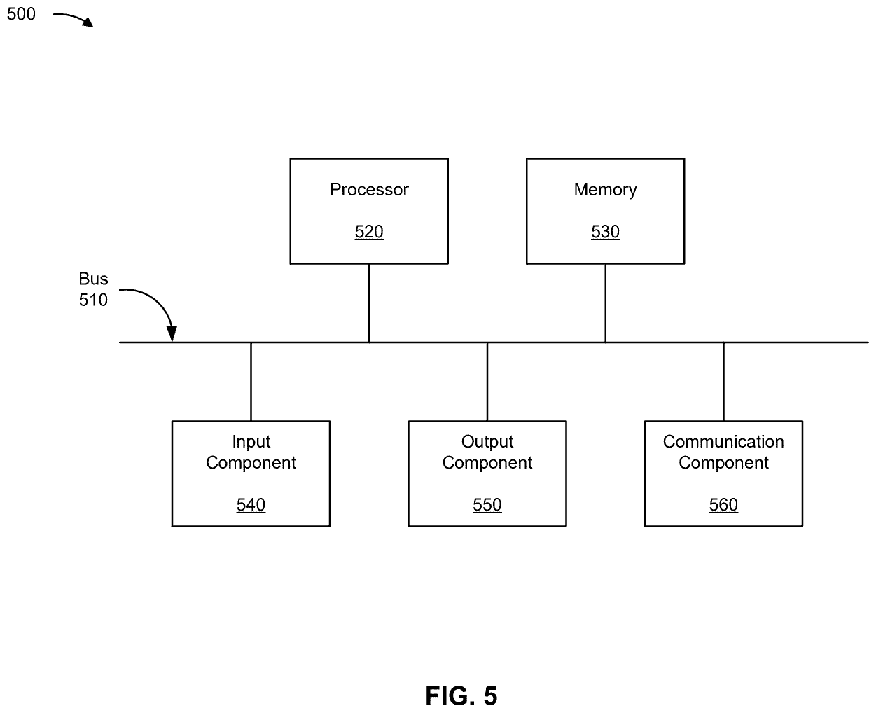

FIG. 5 is a diagram of example components of a device 500 associated with obtaining a timing using an NTP and an SFN. The device 500 may correspond to a UE (e.g., UE 102). In some implementations, the UE may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

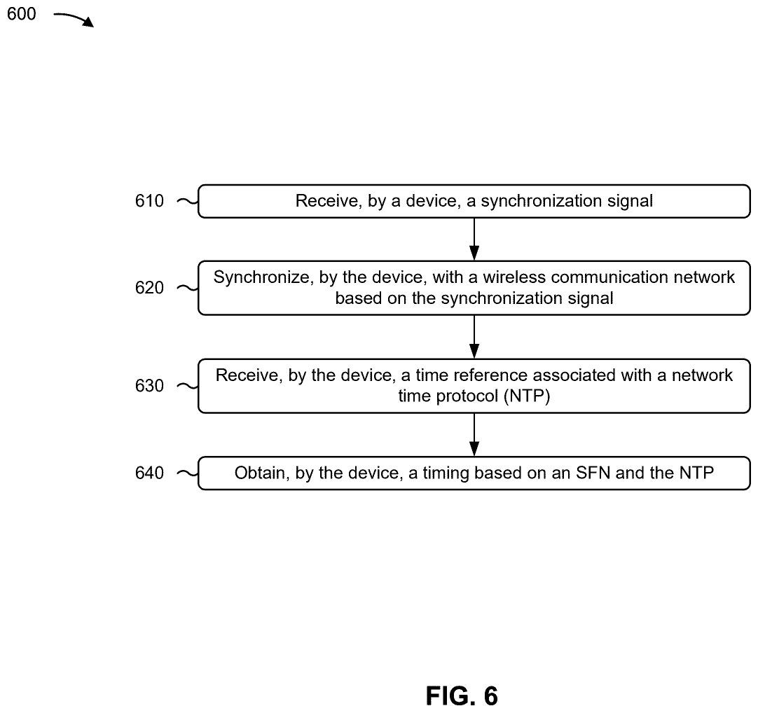

FIG. 6 is a flowchart of an example process 600 associated with obtaining a timing using an NTP and an SFN. In some implementations, one or more process blocks of FIG. 6 may be performed by a UE (e.g., UE 102). In some implementations, one or more process blocks of FIG. 6 may be performed by another entity or a group of entities separate from or including the UE. Additionally, or alternatively, one or more process blocks of FIG. 6 may be performed by one or more components of device 500, such as processor 520, memory 530, input component 540, output component 550, and/or communication component 560.

As shown in FIG. 6, process 600 may include receiving, by the device, a synchronization signal (block 610). The synchronization signal may be a broadcast signal. The device may receive the synchronization signal from a network node associated with a cellular communication network. The synchronization signal may be a PSS, an SSS, and/or a PBCH signal.

As shown in FIG. 6, process 600 may include synchronizing, by the device, with a wireless communication network based on the synchronization signal (block 620). The device may be associated with a radio frame based on the synchronization signal. The radio frame may be associated with an SFN. During a synchronization, the device may be locked on a radio frame boundary associated with the radio frame. The radio frame may be associated with a duration of 10 ms. The SFN may range from 0 to 1023. The SFN may be incremented every 10 ms and repeated every 10.24 seconds.

As shown in FIG. 6, process 600 may include receiving, by the device, a time reference associated with an NTP (block 630). A timing accuracy associated with the time reference may be in the tens of milliseconds, relative to a UTC. The device may receive the time reference associated with the NTP from an NTP server over the Internet. The NTP is an application-layer protocol over IP networks.

As shown in FIG. 6, process 600 may include obtaining, by the device, a timing based on the SFN and the NTP (block 640). The SFN may be combined with the NTP to achieve the time accuracy on the order of a few microseconds. The device may resolve an ambiguity associated with the SFN using the NTP. In other words, the time reference associated with the NTP may be updated using the SFN, thereby achieving the timing accuracy based on the SFN and the NTP.

In some implementations, the device may determine, at a radio frame boundary of the radio frame, the SFN associated with the radio frame based on a GPS time. The GPS time may be based on the time reference associated with the NTP. The GPS time may be based on the SFN and an unknown positive integer representing an ambiguity in a number of SFN cycles that have elapsed since a GPS time zero. The device may determine an estimated GPS time at an SFN=0 boundary from the SFN in accordance with the SFN and the unknown positive integer representing the ambiguity in the number of SFN cycles that have elapsed since the GPS time zero. The device may calculate the ambiguity, for a current SFN cycle, based on an estimated GPS time at an SFN=0 boundary from the NTP. The device may calculate a time difference between the estimated GPS time at the SFN=0 boundary from the SFN and the estimated GPS time at the SFN=0 boundary from the NTP, where the time difference may be associated with the timing accuracy based on the SFN and the NTP. The device may update a system time based on the time difference, wherein a synchronization of the device with the wireless communication network is based on the time difference. The device may provide the time difference to an application running on the device.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a synchronization signal;
synchronizing, by the device, with a wireless communication network based on the synchronization signal, wherein the device is associated with a radio frame based on the synchronization signal, and the radio frame is associated with a system frame number (SFN);
receiving, by the device, a time reference associated with a network time protocol (NTP); and
obtaining, by the device, a timing based on the SFN and the NTP.

2. The method of claim 1, wherein the SFN is set according to a global positioning system (GPS) time, and wherein the GPS time is based on the time reference associated with the NTP.

3. The method of claim 2, wherein the GPS time is estimated based on the SFN and an unknown positive integer, representing an ambiguity in a number of SFN cycles that have elapsed since a GPS time zero.

4. The method of claim 3, further comprising:
determining, by the device, an estimated GPS time at an SFN boundary from the SFN in accordance with the SFN and the unknown positive integer representing the ambiguity in the number of SFN cycles that have elapsed since the GPS time zero.

5. The method of claim 4, further comprising:
calculating, by the device, the unknown positive integer representing the ambiguity, for a current SFN cycle, based on an estimated GPS time at an SFN=0 boundary from the NTP.

6. The method of claim 5, further comprising:
calculating, by the device, a time difference between the estimated GPS time at the SFN boundary from the SFN and the estimated GPS time at the SFN=0 boundary from the NTP, wherein the time difference is associated with the timing based on the SFN and the NTP.

7. The method of claim 6, further comprising:
updating, by the device, a system time based on the time difference, wherein a synchronization of the device with the wireless communication network is based on the time difference.

8. The method of claim 6, further comprising:
providing, by the device, the time difference to an application running on the device.

9. The method of claim 1, wherein the synchronization signal is a primary synchronization signal (PSS), a secondary synchronization signal (SSS), or a physical broadcast channel (PBCH) signal.

10. The method of claim 1, wherein the wireless communication network is a time division duplexing (TDD)-based wireless communication network.

11. A device, comprising:
one or more processors configured to:
receive a synchronization signal;
synchronize with a wireless communication network based on the synchronization signal, wherein the device is associated with a radio frame based on the synchronization signal, and the radio frame is associated with a system frame number (SFN);
receive a time reference associated with a network time protocol (NTP); and
obtain a timing based on the SFN and the NTP.

12. The device of claim 11, wherein the SFN is set according to a global positioning system (GPS) time, and wherein the GPS time is based on the time reference associated with the NTP.

13. The device of claim 12, wherein the GPS time is estimated based on the SFN and an unknown positive integer, representing an ambiguity in a number of SFN cycles that have elapsed since a GPS time zero.

14. The device of claim 13, wherein the one or more processors are further configured to:
determine an estimated GPS time at an SFN boundary from the SFN in accordance with the SFN and the unknown positive integer representing the ambiguity in the number of SFN cycles that have elapsed since the GPS time zero.

15. The device of claim 14, wherein the one or more processors are further configured to:
calculate the unknown positive integer representing the ambiguity, for a current SFN cycle, based on an estimated GPS time at an SFN=0 boundary from the NTP.

16. The device of claim 15, wherein the one or more processors are further configured to:
calculate a time difference between the estimated GPS time at the SFN boundary from the SFN and the estimated GPS time at the SFN=0 boundary from the NTP, wherein the time difference is associated with the timing based on the SFN and the NTP.

17. The device of claim 16, wherein the one or more processors are further configured to:
update a system time based on the time difference, wherein a synchronization of the device with the wireless communication network is based on the time difference.

18. The device of claim 16, wherein the one or more processors are further configured to:
provide the time difference to an application running on the device.

19. The device of claim 11, wherein the synchronization signal is a primary synchronization signal (PSS), a secondary synchronization signal (SSS), or a physical broadcast channel (PBCH) signal.

20. A non-transitory computer-readable medium storing a set of instructions, the set of instructions comprising:
one or more instructions that, when executed by one or more processors of a device, cause the device to:
receive a synchronization signal;
synchronize with a wireless communication network based on the synchronization signal, wherein the device is associated with a radio frame based on the synchronization signal, and the radio frame is associated with a system frame number (SFN);
receive a time reference associated with a network time protocol (NTP); and
obtain a timing based on the SFN and the NTP.
